(19) United States
(12) Patent Application Publication
(10) Pub. No.: US 2002/0158007 A1
(43) Pub. Date: Oct. 31, 2002

(54) Water-purifying filter

(76) Inventor: Ju-Lin Li, Tu Cheng City (TW)

Correspondence Address: SHAW PITTMAN, 1650 TYSONS BLVD., MCLEAN, VA, 22102, US

(21) Appl. No.: 09/842,702

(22) Filed: Apr. 27, 2001

(51) Int. Cl. B01D 39/16

(52) U.S. Cl. 210/497.01; 210/502.1; 210/504

(57) ABSTRACT

A water-purifying filter has a tubular body portion being entirely coated with a polypropylene coating portion during a manufacturing process thereof. The polypropylene coating portion includes a first coating layer bonded to an inner circumferential surface of the tubular body portion when the first coating layer is still viscid, and a second coating layer sprayed onto an outer circumferential surface and two annular end surfaces of the tubular body portion to connect to two ends of the first coating layer. Two ends of the tubular body portion that has been coated by the polypropylene coating portion are sprayed with a waterproof material to form two watertight layers thereat to ensure water to pass both the tubular body portion and the polypropylene coating portion and be filtered and purified twice. The water-purifying filter with such structure does not need costs for storing and assembling separate polypropylene coating and end caps and can therefore be provided at lower cost.

### BACKGROUND OF THE INVENTION

The present invention relates to a water-purifying filter, and more particularly to an integrally formed water-purifying filter having a body portion completely coated by a polypropylene coating during the manufacturing process thereof. Costs for making, storing and assembling separate polypropylene coatings and end caps are therefore saved.

Typically, a conventional water purifier includes several containers for accommodating different filters, including polypropylene (PP), active carbon, Porphyritic Andesite and active coal. These containers are sequentially communicable with one another to provide a full water-purifying process. The PP material preliminarily filters the water to remove impurities and dirt from the water. The preliminarily filtered water keeps flowing through the active carbon, the Porphyritic Andesite and/or the active coal in order to remove odor and color therefrom and to be activated. Thereafter, purified clean water flows out of the water purifier for drinking. The above-described water purifier requires a very large volume to complete the full water-purifying process. The way to reduce the volume of the water purifier is to simplify the purifying process or shorten the purifying path.

There is prior art disclosing a method of manufacturing a filter for water purifying and the method mainly includes screening raw materials, such as adequate amount of Porphyritic Andesite, active carbon or active coal; washing the screened raw materials with clean water to remove dirt from the raw materials; drying the raw materials at high temperature; adding viscid agent into the raw materials and mix them into paste at high temperature; heating and compressing the mixed paste into a soft solid in a molding machine; and cooling and molding the soft solid into a desired filter body 1 in the form of a hollow tube, as shown in FIG. 1.

The filter body produced in the above-described method contains Porphyritic Andesite, active carbon, active coal or a combination thereof to perform the functions of filtering, deodorizing, decolorizing and activating water at the same time. A water purifier using such molded filter body can therefore have shortened purifying path and reduced volume.

However, under the currently available water filtering technology, the tube-shaped filter body 1 manufactured in the above conventional method is used with both its inner and outer circumferential surfaces additionally covered with a layer of tubular filter made of polypropylene 2, and its two ends closed with two caps 3 adhered thereto, as shown in FIG. 1. An integral unit of the filter body 1, the polypropylene layers 2 and the caps 3 is then disposed in a water purifier for use. The polypropylene layer 2 coating an outer surface of the filter body 1 preliminarily filters the water to prevent impurities and dirt in the water from clogging the outer surface of the filter body 1 and thereby prolongs the usable lift of the filter body 1. The polypropylene layer 2 coating an inner surface of the filter body 1 is intended to prevent powder on the inner surface of the filter body 1 from scaling off. And the two end caps 3 enhance connection of the inner and the outer polypropylene layers 2 to the filter body 1, as well as force a water flow from the outer PP layer 2 toward the inner PP layer 2 via the filter body 1 to complete the filtering process. Such molded filter body 1 with PP layers and end caps 3 shows very good filtering performance. However, it also has the following disadvantages:

1. The filter body 1, the PP layers 2, and the end caps 3 are separately produced and stored, and therefore need additional costs for warehousing and managing stocks thereof.

2. The PP layers 2 and the end caps 3 must be additionally assembled to the filter body 1 and therefore requires increased manufacturing cost. Particularly, the inner PP layer 2 has small thickness and therefore weak structural strength, causing difficulty in mounting it into the filter body 1.

### SUMMARY OF THE INVENTION

It is therefore a primary object of the present invention to provide a water-purifying filter that has integrally formed filter body and polypropylene coating layers, and therefore does not require additional costs for storing and assembling separate PP layers.

To achieve the above and other objects, the water-purifying filter of the present invention mainly includes a tubular filter body being manufactured by molding Porphyritic Andesite, active carbon, active coal or a combination thereof into a round hollow tube that is then completely coated with a coating during the manufacturing process. The coating includes a first coating layer bonded to an inner circumferential surface of the tubular filter body when the first coating layer is still viscid, and a second coating layer sprayed onto an outer circumferential surface and two annular end surfaces of the tubular filter body to connect to two ends of the first coating layer. Two ends of the tubular filter body that has been coated by the coating portion are sprayed with a waterproof material to form two watertight layers thereat to ensure water to pass both the filter body and the coating and be filtered and purified twice. The water-purifying filter with such structure does not need costs for making, storing and assembling separate coating and end caps to the tubular body portion and can therefore be provided at lower cost.

In the water-purifying filter of the present invention, the first and the second coating layers coated the solid filter body are made of polypropylene material.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective of a conventional water-purifying filter;

FIG. 2 schematically shows a first step of producing a water-purifying filter according to the present invention;

FIG. 3 schematically shows a second step of producing a water-purifying filter according to the present invention;

FIG. 4 schematically shows a third step of producing a water-purifying filter according to the present invention;

FIG. 5 schematically shows a water-purifying filter according to the present invention before being sprayed with a waterproof plastic material over two ends thereof;

FIG. 6 is a sectional view showing a finished product of a water-purifying filter according to a first embodiment of the present invention;

FIG. 7 is a sectional view showing a water-purifying filter according to a second embodiment of the present invention; and

FIG. 8 is a sectional view showing a water-purifying filter according to a third embodiment of the present invention.

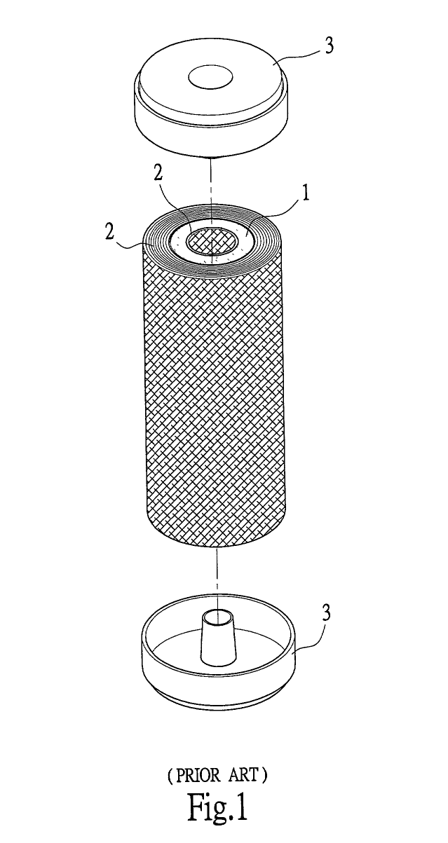

### DETAILED DESCRIPTION OF THE PREFERRED EMBODIMENTS

Please first refer to FIG. 6 that shows a sectioned water-purifying filter according to a first embodiment of the present invention. As shown, the water-purifying filter mainly includes a tubular body portion 1 and a coating portion 4. Both the tubular body portion 1 and the coating portion 4 are made of materials having a filtering function. The tubular body portion 1 is manufactured by molding Porphyritic Andesite, active carbon, active coal or a combination thereof into a round hollow tube having a predetermined wall thickness. The coating portion 4 is made of polypropylene (PP) and includes a first coating layer 41 covering an inner circumferential surface of the hollow tubular body portion 1, and a second coating layer 42 covering an outer circumferential surface and two annular end surfaces of the tubular body portion 1. The water-purifying filter having the above-described structure is further provided at two ends with sprayed waterproof plastic material 5.

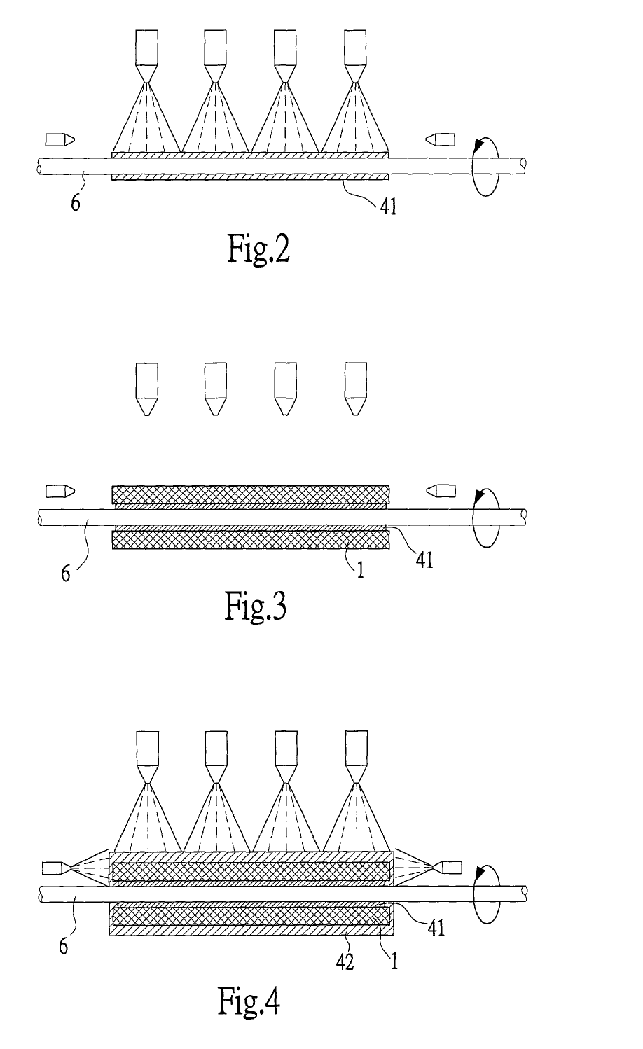

FIGS. 2 through 5 illustrate in details steps of manufacturing the water-purifying filter according to the first embodiment of the present invention:

In a first step as shown in FIG. 2, a polypropylene material is sprayed over an outer surface of a shaft 6 while the latter is kept rotating, so that a first coating layer 41 in the shape of a round hollow tube is formed around the rotating shaft 6.

In a second step as shown in FIG. 3, a prefabricated tubular body portion 1 in the form of a round hollow tube is put around the first coating layer 41 on the shaft 6 before the first coating layer 41 is set, so that the first coating layer 41 is bonded to an inner circumferential surface of the hollow tubular body portion 1.

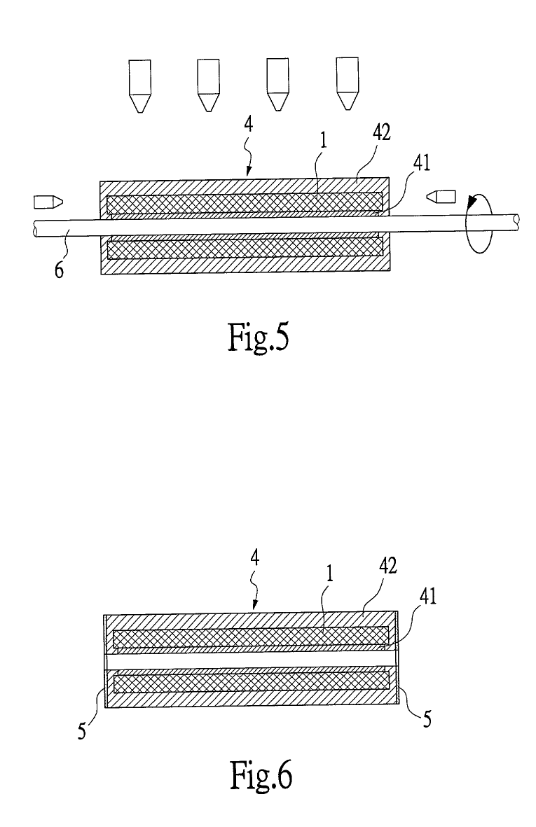

In a third step as shown in FIG. 4, a polypropylene material is sprayed over an outer circumferential surface and two annular end surfaces of the tubular body portion 1, so that a second coating layer 42 is formed to cover the entire outer surface of the tubular body portion 1, including the outer circumferential surface and the two annular end surfaces, and to connect to two ends of the first coating layer 41, making the entire tubular body portion 1 coated by a coating portion 4 formed from the first and the second coating layers 41, 42 integrally connected to each other. FIG. 5 shows a product of the water-purifying filter completed up to this third step.

In a fourth step, the water-purifying filter obtained in the third step is sprayed at two ends with a waterproof plastic material to form watertight layers 5 at two ends of the filter, as shown in FIG. 6. At this point, a water-purifying filter having a tubular body portion 1 completely covered by a polypropylene coating portion 4 is completed and ready for use.

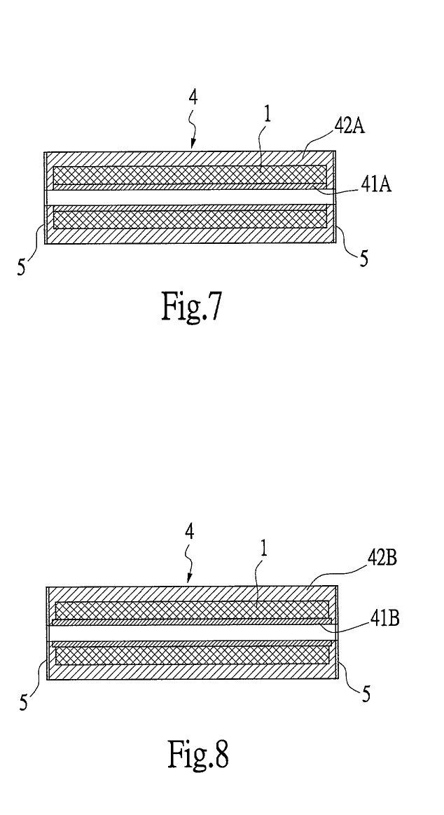

In manufacturing the water-purifying filter according to the first embodiment of the present invention as shown from FIGS. 2 to 6, the first coating layer 41 has an overall length slightly smaller than that of the tubular body portion 1, and the second coating layer 42 is extended into the inner circumferential surface of the hollow tubular body portion 1 to connect to two ends of the first coating layer 41 to form an integral coating portion 4. However, since the sprayed polypropylene material is viscid before becoming set, it is not necessary for the first coating layer 41 to always be shorter than the second coating layer 42. In a second embodiment of the present invention shown in FIG. 7, there is shown a first coating layer 41A having an overall length equal to that of the tubular body portion 1. In this case, a second coating layer 42A is connected to the first coating layer 41A at the end surfaces of the tubular body portion 1 to form an integral coating portion 4. And, in a third embodiment of the present invention shown in FIG. 8, there is shown a first coating layer 41B having an overall length longer than that of the tubular body portion 1. In this case, a second coating layer 42B can still be connected to the first coating layer 41B at the end surfaces of the tubular body portion 1 to form an integral coating portion 4.

The water-purifying filter having a tubular body portion 1 completely covered by a polypropylene coating portion of 4 allows omission of assembling two caps to two ends of the molded filter body, the water-purifying filter of the present invention can therefore be manufactured in simplified manner to save costs for making, warehousing, and assembling separate caps and polypropylene filter materials.

The watertight plastic layers 5 sprayed onto two ends of the polypropylene-coated water-purifying filter are intended to stop water from flowing via two ends of the tubular body portion during the purifying process, so as to ensure that water flows through both the polypropylene coating layers 41, 42 and the tubular body portion 1 and be filtered and purified twice.

In conclusion, the water-purifying filter of the present invention has the following advantages:

1. It is no need to additionally prepare the separate inner and outer polypropylene layers as well as the end caps for the tubular body portion of the filter. Costs for storing the polypropylene layers and the end caps can therefore be saved.

2. It is no need to assemble the inner and outer polypropylene layers to the tubular body portion or to adhere the end caps to two ends of the tubular body portion. Costs and equipment for such assembling and adhering can therefore be saved.

What is claimed is:

1. A water-purifying filter, comprising a tubular body portion being manufactured by molding Porphyritic Andesite, active carbon, active coal or a combination thereof into a round hollow tube having a predetermined wall thickness, and being coated with a coating portion; said coating portion including a first coating layer bonded to an inner circumferential surface of said hollow tubular body portion when said first coating layer is still viscid, and a second coating layer sprayed onto an outer circumferential surface and two annular end surfaces of said tubular body portion to connect to two ends of said first coating layer and thereby form an integral coating portion; and a waterproof plastic material being sprayed onto two ends of said tubular body portion having been coated by said coating portion to form two watertight layers that ensure water to pass both said tubular body portion and said coating portion and be filtered and purified twice.

2. A water-purifying filter as claimed in claim 1, wherein said coating portion is made of a polypropylene material.

3. A water-purifying filter as claimed in claim 1, wherein said first coating layer has an overall length slightly smaller than that of said tubular body portion.

4. A water-purifying filter as claimed in claim 1, wherein said first coating layer has an overall length slightly larger than that of said tubular body portion.

5. A water-purifying filter as claimed in claim 1, wherein said first coating layer has an overall length equal to that of said tubular body portion.
